(19) United States
(12) Patent Application Publication
(10) Pub. No.: US 2021/0112732 A1
(43) Pub. Date: Apr. 22, 2021

(54) ROW CROP THERMAL PLANT TREATMENT MACHINE

(71) Applicants: Lazo TPC Global, Inc. dba Agrothermal Systems, Napa, CA (US); AEOLO TECNOAG S.A. DE C.V., San Juan Del Rio (MX)

(72) Inventors: Martin Fischer, Pleasant Hill, CA (US); Timothy Raymond Allen Matson, Napa, CA (US); Alejandro Azuara Cardenas, San Juan del Rio (MX); Adrian Teodoro Rivera Felix, Apaseo El Grande (MX)

(21) Appl. No.: 17/075,201

(22) Filed: Oct. 20, 2020

Related U.S. Application Data
(60) Provisional application No. 62/923,993, filed on Oct. 21, 2019.

(51) Int. Cl. A01G 13/06

(52) U.S. Cl. CPC A01G 13/06

(57) ABSTRACT

A thermal plant treatment (TPT) machine is configured to apply heated air to crops to induce commercially beneficial effects in the target plants. The TPT machine includes a thermal assembly with interchangeable vents for applying the heat treatment. The thermal assembly includes a heater duct, blowers mounted on the heater duct, a heater supported by the blowers, and a vent assembly mounted to the heater duct. The blower is configured to generate and provide an airstream to the heater duct. The heater is configured to increase a temperature of the heater duct at a location downstream of the blower to generate a heated airstream. The vent assembly is configured to receive the heated airstream from the heater duct and eject the heated airstream onto a target. The vent assembly includes interchangeable vents configured to alter the flow of the airstream exiting the vent assembly.

### CROSS-REFERENCE TO RELATED APPLICATION(S)

This application claims the benefit of U.S. Provisional Application No. 62/923,993 filed Oct. 21, 2019 for “ROW CROP THERMAL PLANT TREATMENT MACHINE” by M. Fischer, T. R. A. Matson, A. A. Cardenas and A. T. R. Felix, the disclosure of which is hereby incorporated by reference in its entirety.

### BACKGROUND

The present disclosure relates generally to agricultural machines. More specifically, the present disclosure relates to agricultural machines for treating row crops with applications of heated air.

Thermal treatment in agriculture has been used to control pests and diseases and prevent damage to plants caused by low environmental temperatures and adverse weather conditions such as rain. The thermal treatment is utilized to minimize loss of the crop due to the pests, diseases, and adverse climatic issues. Some machines are used to blow a large volume of heated air over a full field, to provide a heated layer that prevents frost damage to the crop. Heat treatment has also been utilized to defoliate certain crops, such as cotton, in preparation for harvest by applying flames directly to the target plants.

### SUMMARY

According to one aspect of the disclosure, a thermal plant treatment (TPT) machine includes a frame, a thermal assembly mounted to the frame, and a vent assembly extending from the thermal assembly. The thermal assembly includes a heater duct, a blower assembly mounted on the heater duct, and a heater supported by the blower assembly. The blower assembly is configured to generate and provide an airstream to the heater duct. The heater is configured to increase a temperature of the airstream within the heater duct at a location downstream of the blower assembly to generate a heated airstream. The vent assembly is configured to receive the heated airstream from the heater duct and eject the heated airstream onto a target plant.

### BRIEF DESCRIPTION OF THE DRAWINGS

FIG. 1A is a first isometric view of a row crop machine.

FIG. 1B is a second isometric view of the row crop machine.

FIG. 1C is a rear elevation view of the row crop machine.

FIG. 1D is a front elevation view of the row crop machine.

FIG. 1E is a top plan view of the row crop machine.

FIG. 1F is a right side elevation view of the row crop machine.

FIG. 1G is a left side elevation view of the row crop machine.

FIG. 1H is a side elevation view of the row crop machine in a collapsed state.

FIG. 2A is a partially exploded isometric view of thermal assembly with a portion of the heater duct removed.

FIG. 2B is a side elevation view of the thermal assembly shown in FIG. 2A.

FIG. 2C is a front elevation view of the thermal assembly shown in FIG. 2A.

FIG. 2D is an isometric view showing blowers with a portion of the blower housing removed.

FIG. 2E is an isometric view of thermal assembly with a splitter.

FIG. 3A is a front isometric view of a heater.

FIG. 3B is a rear isometric view of a heater.

FIG. 4A is an isometric bottom view of a first vent assembly.

FIG. 4B is a bottom plan view of the first vent assembly.

FIG. 4C is an isometric view of a second vent assembly.

FIG. 4D is a bottom plan view of the second vent assembly.

FIG. 5 is a schematic block diagram of a first control system for a row crop machine.

FIG. 6 is a schematic block diagram of a second control system for a row crop machine.

FIG. 7A is an isometric view of a row crop machine in a vertical treatment configuration.

FIG. 7B is an isometric view of a row crop machine in a vertical treatment configuration.

FIG. 8 is a close-up isometric view of a hinge with a stop sensor.

### DETAILED DESCRIPTION

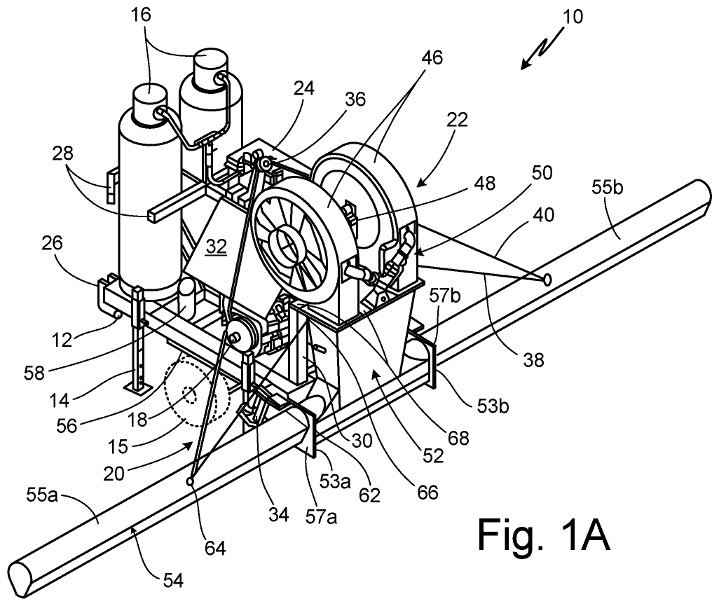

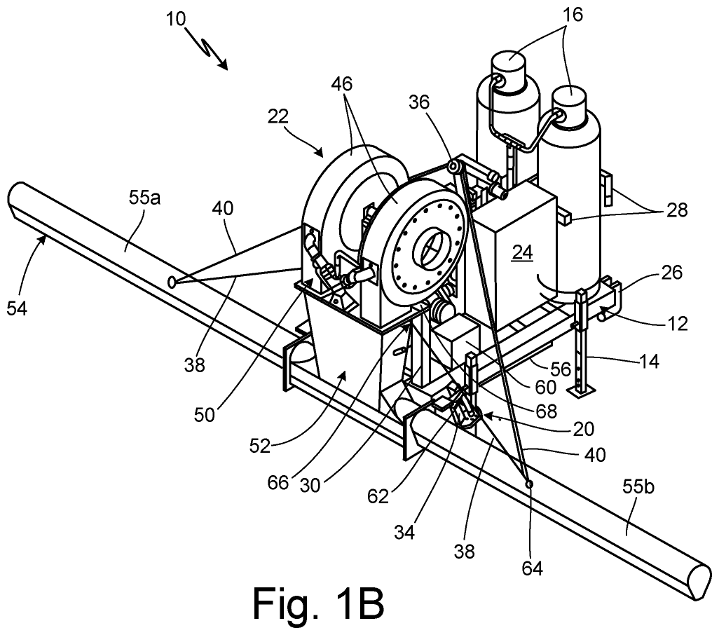

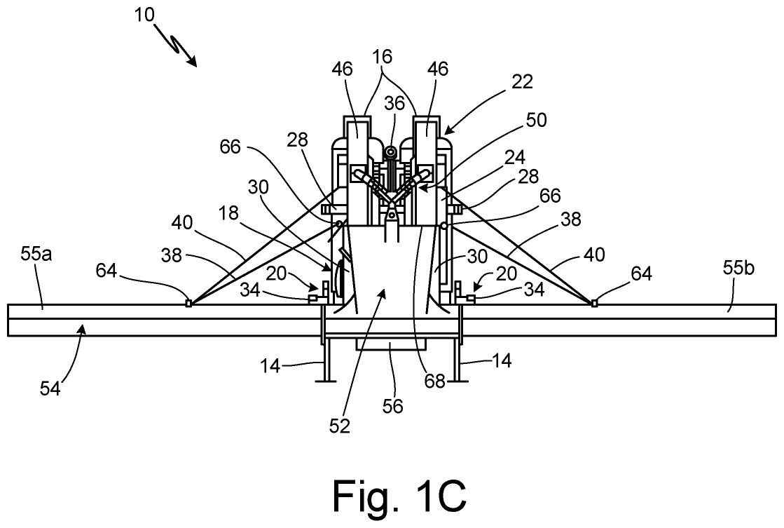

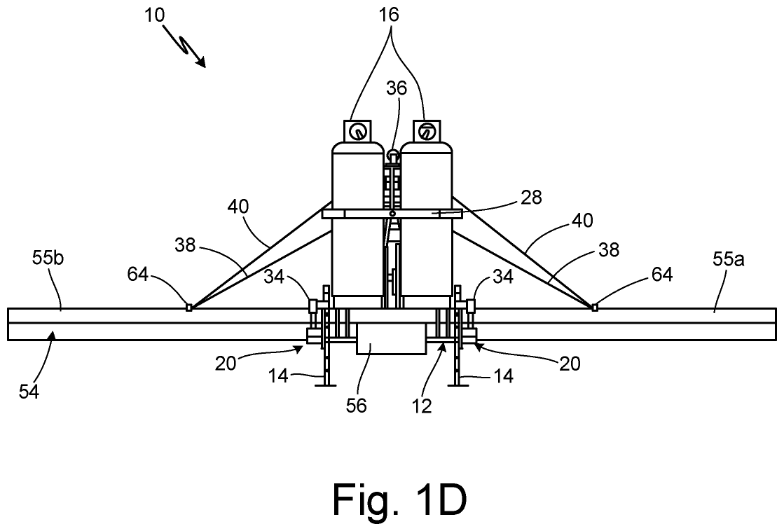

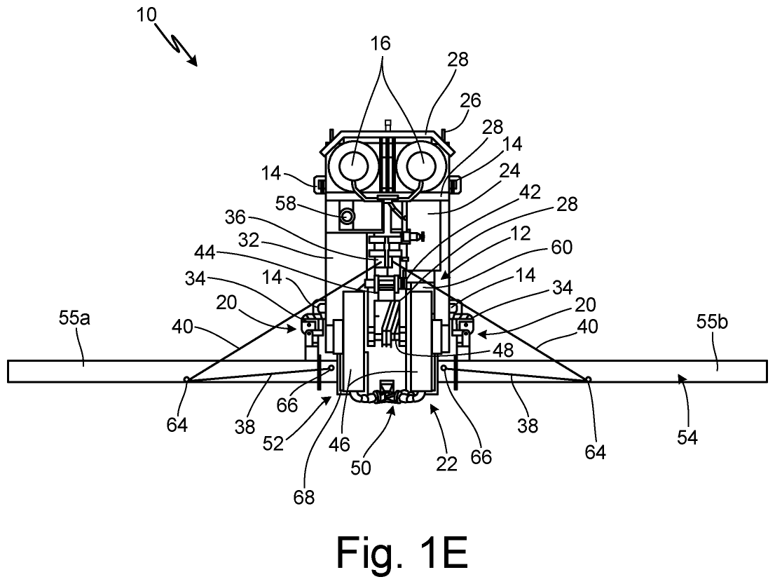

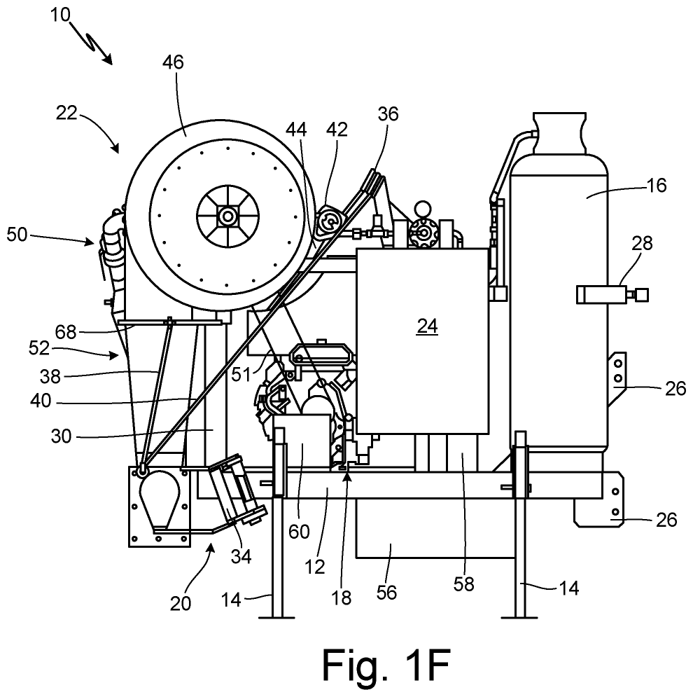

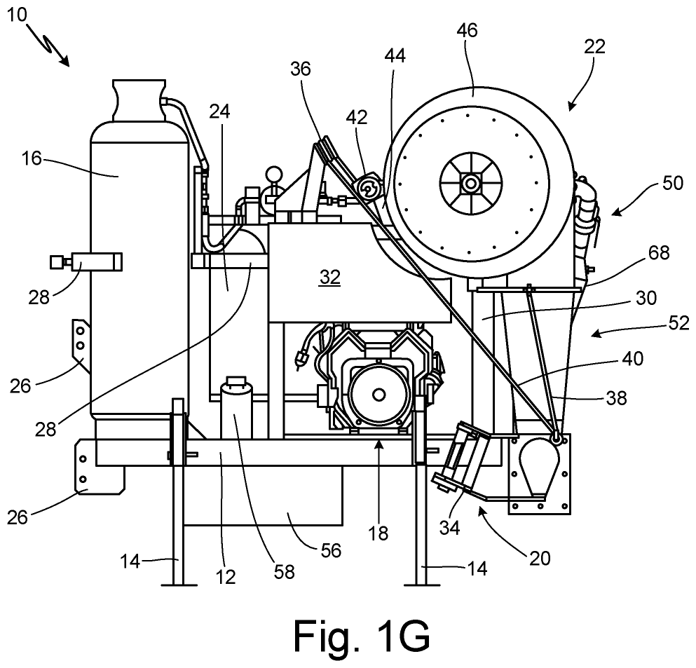

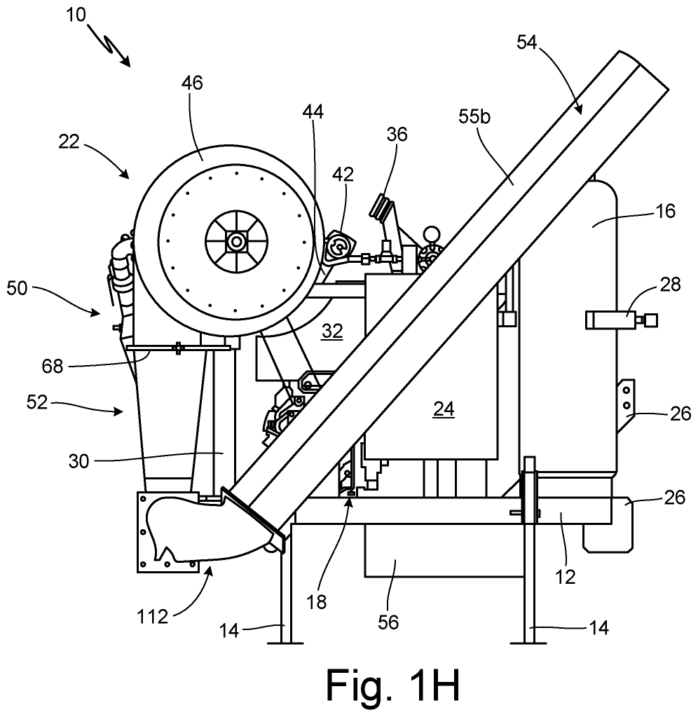

FIG. 1A is a first isometric view of row crop machine 10. FIG. 1B is a second isometric view of row crop machine 10. FIG. 1C is a front view of row crop machine 10. FIG. 1D is a rear view of row crop machine 10. FIG. 1E is a top view of row crop machine 10. FIG. 1F is a right side view of row crop machine 10. FIG. 1G is a left side view of row crop machine 10. FIG. 1H is a side view of row crop machine 10 in a collapsed state. FIGS. 1A-1H will be discussed together. Row crop machine 10 includes frame 12, jacks 14, fuel tanks 16, power source 18, pivot assembly 20, thermal assembly 22, and controller 24. Frame 12 includes hitch 26, support arms 28, main support 30, and power source cover 32. Pivot assembly 20 includes hinge 34, pulley 36, wire tensor 38, vent wire 40, winch 42, and winch support 44. Thermal assembly 22 includes blowers 46, blower shaft 48, heater 50, heater duct 52, and vent assembly 54.

Row crop machine 10 is a machine for applying a thermal plant treatment (TPT) process to row crops. For example, row crop machine 10 can treat row crops during TPT. The row crops can include both vertical rows crops, such as those grown on trellises, and/or horizontal row crops, such as those grown in fields. During TPT, row crop machine 10 traverses a field and thermal assembly 22 generates heat and applies streams of heated air to the crops. Thermal assembly 22 is configured to generate exit air speeds of 10 km/hr-250 km/hr. The heated air can have a temperature ranging from 15° C. to 350° C., or higher. Row crop machine 10 continuously moves through the field throughout the application process such that each plant receives an application of heated air for a limited duration. The heated air is preferably applied such that the air impinges on the target plant in one treatment area of the target plant for a period of up to 15 seconds. It is understood, however, that the specific treatment period can be longer or shorter than 15 seconds. The treatment area shifts with row crop machine 10 as row crop machine 10 traverses the field and vent assembly 54 passes the crops.

Row crop machine 10 can apply heat treatments to the target plant to kill pests and diseases and/or induce a biochemical and/or physiologic reaction in the treated crops. In some examples, row crop machine 10 applies a series of heat treatments to the crops to induce a biochemical and/or physiologic reaction in the treated crops. The biochemical and/or physiologic reaction induced by the series of heat treatments causes the treated crops to express commercially desirable traits, such as brighter color; larger fruit; thicker skin; higher weight; greater yield; increase in fruit set; even yield; higher phenol levels; higher antioxidant levels; higher sugar levels; a decreased time to harvest; thicker leaves, which can result in higher photosynthetic activity; decreased time to flowing; and induction of systemic acquired resistance to improve plant tolerance to changing environmental factors; among other commercially desirable effects. Row crop machine 10 can also treat the target crop for insects and fungi. Row crop machine 10 can heat the air to sufficiently high temperatures to kill insects, fungi and bacteria which is killed instantly at temperature of over about 70 degrees C. (about 160 degrees Fahrenheit). For example, the heated air can kill fungal pests such as Oidium and Botritis, and can kill insect pests such as white fly. Exterminating insects and fungi with heated air reduces the use of chemicals such as pesticides and fungicides, thereby decreasing environmental impact and reducing costs to the user.

TPT can be applied at a variety of intervals and at various stages of plant growth to induce desirable changes in the target plant. The TPT process can be applied at the stages between budding and fruit set, between fruit set and harvest, and during any desired combination of stages. TPT can also be applied at any desired interval, such as daily, weekly, bi-weekly, or any other desired interval. In some examples, the protocol utilized to treat the target crops for the desired purpose can vary due based on the time of year, the stage of plant growth, and the weather, among other factors.

Frame 12 supports various components of row crop machine 10. Hitch 26 is disposed at a front end of frame 12 and is configured to connect row crop machine 10 to a tow vehicle. In some examples, hitch 26 is a three-point hitch that secures row crop machine 10 to the tow vehicle such that the tow vehicle can fully support row crop machine 10 relative to the ground surface. In other examples, hitch 26 can be articulable. In the example shown, jacks 14 are attached to frame 12 and are configured to adjust the height of row crop machine 10 over the ground. With row crop machine 10 attached to and fully cantilevered off a tow machine, jacks 14 are lifted off the ground and remain off the ground during use of row crop machine 10. In some examples, jacks 14 can be retracted once row crop machine 10 is supported by the tow machine. Jacks 14 support the weight of row crop machine 10 when row crop machine 10 is removed from the tow machine. In some examples, jacks 14 can be replaced with wheels 15, as shown in dashed lines in FIG. 1A, or a combination of wheels 15 and jacks 14. The wheels can be connected to frame 12 and support row crop machine 10 as row crop machine 10 traverses the field. The wheels allow row crop machine 10 to be pulled by any desired tow vehicle, such as an all-terrain vehicle or a tractor. The wheels can be removed from row crop machine 10 in examples where hitch 26 is a three-point hitch 26 and the tow vehicle supports the full weight of row crop machine 10. In some examples, the wheels and jacks 14 are interchangeable such that row crop machine 10 is modular between support configurations.

Fuel tanks 16, 56 are supported on frame 12 and configured to store a supply of fuel for heater 50, and in some examples, for power source 18. Support arms 28 of frame 12 extend around fuel tanks 16 and are configured to secure fuel tanks 16 when row crop machine 10 is in use. Fuel tanks 16 are connected to heater 50 by fuel lines to provide fuel to heater 50. Fuel tanks 16 can store any desired fuel for combustion by heater 50, such as natural gas, liquid propane, and other liquefied petroleum gasses, among other options. While heater 50 is described as fuel-burning, it is understood that heater 50 can generate heat in any desired manner. For example, heater 50 can include electric heating coils. Fuel tank 56 can provide fuel, such as gasoline among other options, to power source 18 when power source 18 is a fuel powered generator. Fuel tank 56 can be attached to an underside of frame 12 and a user can fill fuel tank 56 with fuel through fuel inlet 58. Fuel inlet 58 extends through a floor of row crop machine 10 from a top surface of fuel tank 56 and is configured to receive fuel using standard means.

Power source 18 is supported by frame 12 and is configured to provide power to various components of row crop machine 10. Row crop machine 10 is shown as having an on-board power source 18, but it is understood that row crop machine 10 can include more than one on-board power source 18 or no on-board power source 18. Power source 18 is configured to provide electric power to components of row crop machine 10 and can be either fuel-powered or mechanically driven.

In examples where power source 18 is fuel burning, power source 18 can be connected to fuel tank 56 to receive fuel, which power source 18 combusts to generate electricity. For example, power source 18 can be connected to battery 60 to charge battery 60. Battery 60 is disposed on frame 12 proximate power source 18 and it generates the electricity for the various components of row crop machine 10. Battery 60 can be disposed at any suitable location on frame 12. Power source 18 being a fuel-powered generator allows row crop machine 10 to be towed by any desired tow vehicle, even where that vehicle is unable to directly provide power to row crop machine 10.

In other examples, power source 18 can be a mechanically driven electric generator. In such examples, row crop machine 10 does not include battery 60 and power source 18 instead provides electricity directly to the various components of row crop machine 10. For example, power source 18 can connect to a power takeoff (PTO) shaft of a farming implement. The PTO shaft is mechanically connected to power source 18 to drive power source 18 to generate electricity.

Power source 18 can be disposed at any suitable location on frame 12. For example, power source 18 can be mounted on top of frame 12, particularly where power source 18 is fuel powered. In other examples, power source 18 can be mounted to a bottom of frame 12 proximate hitch 26 to facilitate connection of power source 18 with the PTO shaft. It is understood that, in some examples, row crop machine 10 does not include an on-board power source 18 but is instead directly electrically connected to the tow vehicle to receive electrical energy from the tow vehicle.

Power source 18 provides power to ignitor 90 of heater 50 to cause ignitor 90 to ignite the fuel from fuel tanks 16, in examples where heater 50 is fuel-burning. In other examples where heater 50 is electrically powered, power source 18 provides electrical energy to power heater 50. Power source 18 also provides energy to blower shaft 48 to power blowers 46 and generate an air stream. Power source cover 32 is positioned above power source 18 and is configured to protect power source 18 from environmental conditions that could be harmful to the operation of power source 18. More specifically, power source cover 32 is configured to prevent rain, snow, dirt, and other debris from entering cavities of power source 18.

Pivot assembly 20 includes hinges 34, pulley 36, wire tensors 38, vent wires 40, winch 42, and winch support 44. Hinges 34, wire tensors 38, and vent wires 40 are located on both first and second sides of row crop machine 10; therefore, there are two of each of these components included in pivot assembly 20. It is understood, however, that pivot assembly 20 can include a single hinge 34, wire tensor 38, and vent wire 40.

Hinge 34 is a movable joint with one end of hinge 34 connected to frame 12 and the other end of hinge 34 connected to a side of vent assembly 54. The ends of hinge 34 can connect to frame 12 and vent assembly 54 through a welded connection, bolted connection, or combination thereof. Hinge 34 is configured to rotate about pivot point 62 of hinge 34, allowing vent assembly 54 to rotate at an upward angle away from heater duct 52 and toward power source cover 32, into the collapsed state of vent assembly 54 (FIG. 1H). Hinge 34 can include a spring that is configured to induce a force on hinge 34 to bias vent assembly 54 towards an extended state (FIG. 1A). Although described in a specific configuration, it is understood that hinge 34 can be any apparatus that allows vent assembly 54 to rotate upwards away from the ground surface.

Pulley 36 is positioned atop and secured to support arms 28 of frame 12 through a bracket or any other suitable means. The bracket supporting pulley 36 can be connected to support arms 28 through a welded connection, bolted connection, or combination thereof. Pulley 36 is attached to the supporting bracket in a manner that allows pulley 36 to rotate about its central axis, such as a bearing, bushing, or other suitable means. Pulley 36 is a circular apparatus that includes grooves configured to accept vent wires 40. Pulley 36 is configured to rotate as vent wires 40 are pulled through the grooves of pulley 36. Pulley 36 is used to change the direction of vent wire 40 as vent wire 40 is pulled through the grooves of pulley 36.

Wire tensor 38 is attached at one end to first attachment point 64 positioned on vent assembly 54 and attached at the other end to second attachment point 66 positioned on thermal assembly 22. Wire tensors 38 are configured to remain in tension and support a portion of the weight of vent arms 55a, 55b of vent assembly 54 when vent assembly 54 is in the extended state. Wire tensor 38 can be a cable, chord, rope, line, strand, or thread constructed from a metal or polymer. First loop 64 and second loop 66 can be any rigid connection that allows wire tensor 38 to support vent assembly 54. In the example shown, second loop 66 is connected at the interface between heater duct 52 and blower 46. In other examples, second loop 66 can be mounted to frame 12. For example, first loop 64 and second loop 66 can be metal loops that are welded to vent assembly 54 and heater duct 52, respectively.

Vent wire 40 is attached at one end to first loop 64 and attached at the other end to winch 42. First loop 64 can be any rigid connection that allows connection of vent wire 40 between vent assembly 54 and winch 42. Vent wire 40 can be a cable, chord, rope, line, strand, or thread constructed from a metal or polymer. Vent wire 40 is configured to remain in tension and support a portion of the weight of vent assembly 54 when vent assembly 54 is in the extended state. It is understood, however, that wire tensors 38 can fully support the weight of the portions of vent assembly 54 with vent assembly 54 in the extended state. Vent wires 40 extend into the grooves of pulley 36 and the flexible nature of vent wire 40 allows vent wire 40 to wrap around the circular body of pulley 36. Vent wire 40 extends from first loop 64, wraps around pulley 36, and connects to winch 42. Vent wire 40 is supported by pulley 36 as pulley 36 rotates while vent wire 40 is being wound by winch 42.

Winch 42 is attached to winch support 44 and winch support 44 is attached to support arms 28 of frame 12. Winch support 44 is configured to secure winch 42 to frame 12 of row crop machine 10. Winch support 44 can be any type of bracket suitable for securing winch 42 and preventing movement of winch 42 during operation of winch 42. Winch 42 can be bolted or clamped to winch support 44 to secure winch 42 to winch support 44. In other examples, winch 42 can be permanently connected to winch support 44 through a welded connection or any other standard permanent connection means. Winch 42 is configured to receive electrical power from power source 18 through electrical wires connecting winch 42 to power source 18. Winch 42 includes an electric motor that rotates a drum within winch 42 to wind and wrap vent wire 40 around the drum. The winding of vent wire 40 about the rotating drum causes vent wire 40 to be pulled through the grooves of pulley 36, causing vent assembly 54 to rotate upwards about pivot point 62 into the collapsed state. In the collapsed state, vent arms 55a, 55b are no longer extended outward and instead are folded up adjacent the sides of row crop machine 10. In some examples, winch 42 can be configured to simultaneously wind vent wires 40 on both sides of row crop machine 10 to rotate both vent arms 55a, 55b into the collapsed state. In other examples, row crop machine 10 can include a second winch 42 with each winch 42 dedicated to one side of row crop machine 10. Having multiple winches 42 allows each vent arm 55a, 55b to be independently collapsed and extended.

In the example shown, first loop 64 is an attachment point for the ends of both wire tensor 38 and vent wire 40. In another example, first loop 64 can be replaced with a pulley and wire tensor 38 and vent wire 40 can be combined into a single wire. In this example, the single wire could be attached to second loop 66 at one end of the single wire, wrapped around the pulley replacing first loop 64, extend from the replacement pulley to pulley 36, wrap around pulley 36, and connect to winch 42 at the other end of the single wire. In such an example, winch 42 would pull the single wire through both pulleys and wrap the single wire around the rotating drum. As a result, vent assembly 54 rotates upward about pivot point 62, into the collapsed state of vent assembly 54. In either example, winch 42 is configured to wind and unwind vent wire 40 or the single wire to cause vent assembly 54 to rotate from the extended state to the collapsed state or the collapsed state to the extended state, respectively.

Vent assembly 54 can be folded or rotated into the collapsed state to reduce the overall width of row crop machine 10 when row crop machine 10 is not in use. Reducing the overall width of row crop machine 10 allows for easier storage of row crop machine 10 and allows row crop machine 10 to be transported on public roadways, where local laws may restrict the width of vehicles on the roadways. Vent assembly 54 can also be moved to the collapsed state when it is necessary for row crop machine 10 to treat plants or crops that grow vertically, such as plants or crops that grow on a trellis (discussed further below). In some examples, vent assembly 54 does not treat crops in the collapsed state but instead is placed in the collapsed state for transport.

Thermal assembly 22 includes blowers 46, blower shaft 48, heater 50, heater duct 52, and vent assembly 54. Main support 30 of frame 12 extends vertically above frame 12 and is attached to flange 68 extending from heater duct 52. Main support 30 and support arms 28 are attached to flange 68 through a welded connection or bolted connection and provide support to thermal assembly 22, securing thermal assembly 22 during operation of row crop machine 10. Thermal assembly 22 is configured to generate a stream of air, heat the stream of air to generate a heated stream of air, and direct the heated stream of air onto the target crop. Although described as using blower 46 to generate the airflow, the airflow can be created using any type of axial or centrifugal blower or compressor or a fan of any other type suitable for creating an airflow and blowing the airflow through thermal assembly 22. Thermal assembly 22 and vent assembly 54 can be constructed and manufactured from carbon steel, stainless steel, or any other type of alloy, among other options.

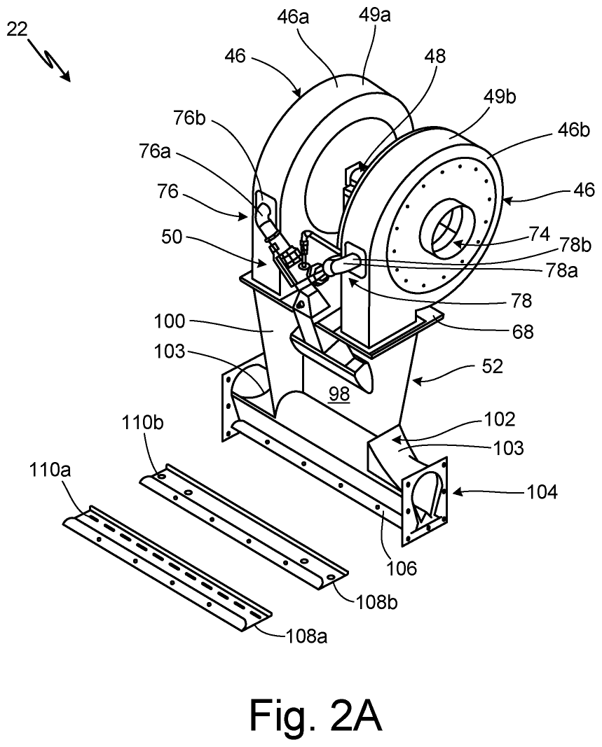

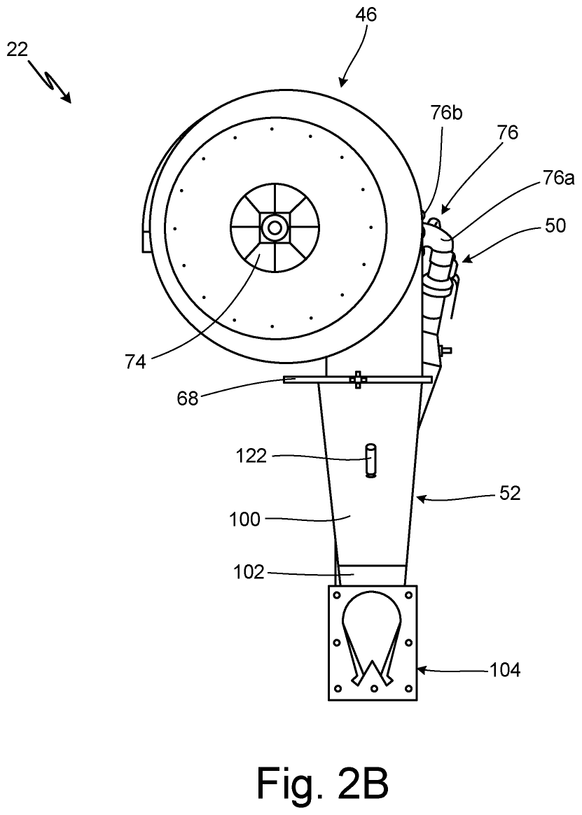

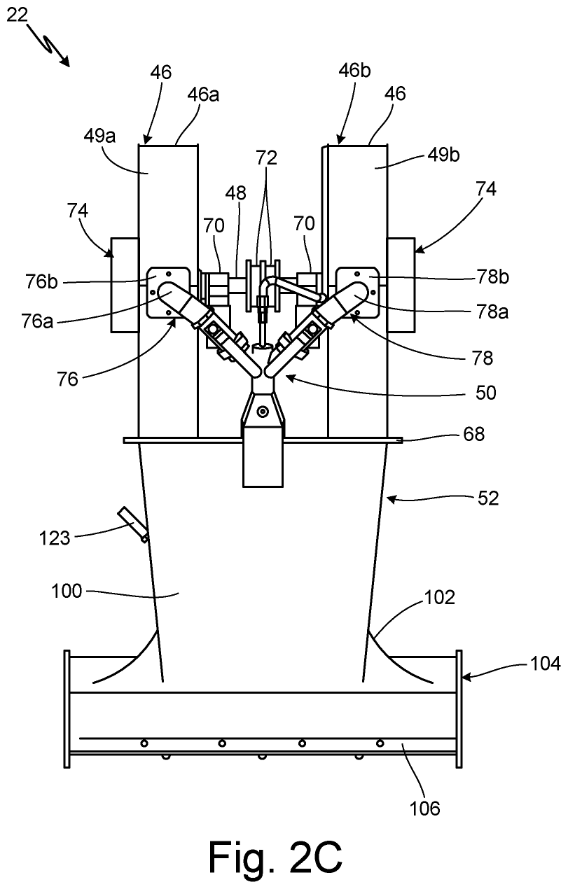

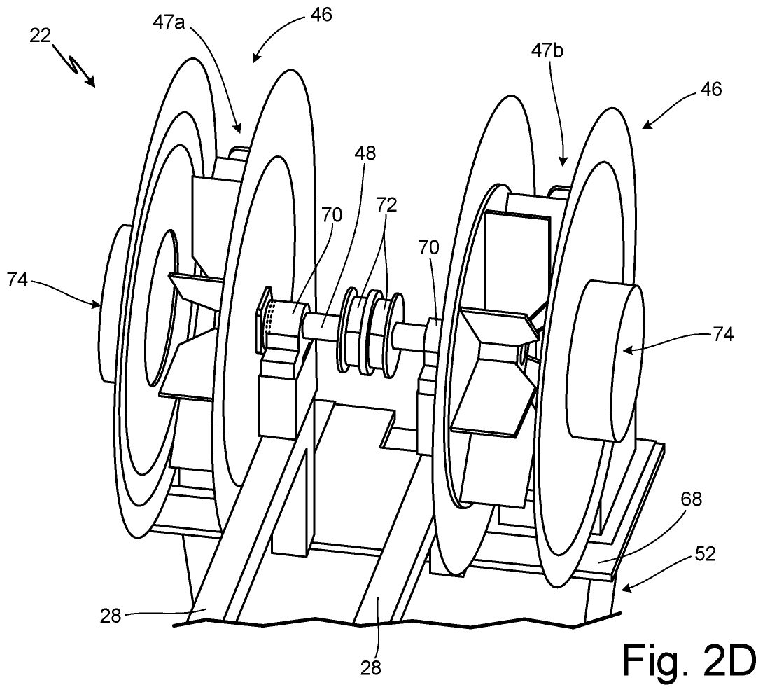

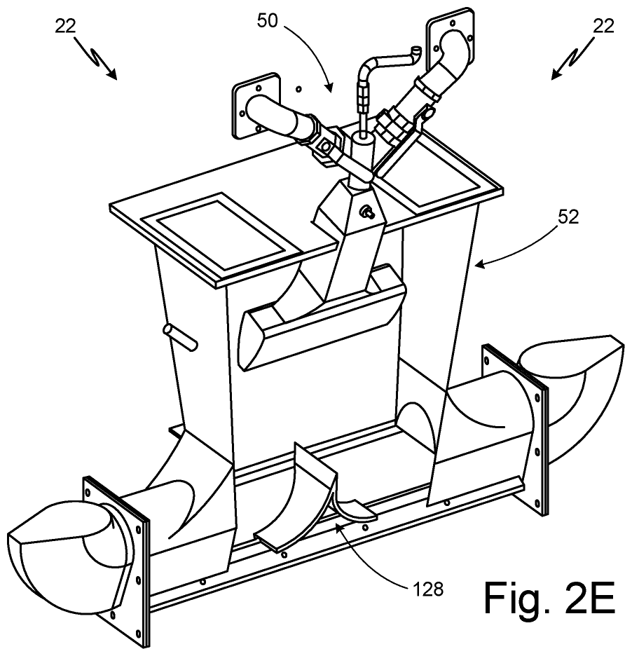

FIG. 2A is an isometric view of thermal assembly 22. FIG. 2B is a side view of thermal assembly 22. FIG. 2C is a front view of thermal assembly 22. FIG. 2D is an isometric view of blowers 46, blower shaft 48, heater duct 52, and support arms 28. FIG. 2E is an isometric view of thermal assembly 22 with a portion of heater duct 52 removed to expose the interior of heater duct 52 and show splitter 128. FIGS. 2A-2E will be discussed together. Thermal assembly 22 includes blowers 46, blower shaft 48, heater 50, and heater duct 52.

Heater duct 52 is connected to and supports each of blowers 46, heater 50, and vent assembly 54. Blowers 46 are mounted to flange 68 of heater duct 52 through a welded connection, bolted connection, or other suitable connection. Blowers 46 are configured to generate the stream of air that flows through thermal assembly 22. As best seen in FIG. 2D, blower shaft 48 is supported by support arms 28 and connected to fans 47a, 47b. Support arms 28 of frame 12 are configured to provide structural support to blower shaft 48 through bearing supports 70 attached to support arms 28. Blower shaft 48 is connected to both of blowers 46 such that fans 47a, 47b are powered by a single shaft that provides rotational power to fans 47a, 47b. Blower shaft 48 includes belt grooves 72 configured to receive a belt 51 (FIG. 1F)). The belt is connected at one end to belt grooves 72 and connected at the other end to power source 18 (FIG. 1F). Rotation of a shaft of power source 18 causes the belt to rotate and thus provides power to blower shaft 48. The rotation of blower shaft 48 powers the centrifugal fans 47a, 47b disposed within the housings 49a, 49b of blowers 46. Blowers 46 pull air in through intake 74, compress the air, and blow streams of air into heater duct 52.

Heater 50 is connected to and supported by blowers 46 and extends into heater duct 52. More specifically, heater 50 is connected to first blower 46a at first air inlet 76 and second blower 46b at second air inlet 78. Heater 50 can be structurally connected to housings 49a, 49b. First air inlet 76 includes first tubing 76a and first plate 76b. In some examples, first tubing 76a is attached to first plate 76b, such as through a welded connection. In other examples, first tubing 76a extends through first plate 76b and first plate 76b presses a portion of first tubing 76a into sealing contact with blower housing 49a. First plate 76b is adjacent a flat surface of blower housing 49a of first blower 46a and secured to blower housing 49a through a bolted connection. First plate 76b can include a seal that contacts first blower 46a and facilitates the airtight seal between first plate 76b and first blower 46a.

Second air inlet 78 includes second tubing 78a and second plate 78b. In some examples, second tubing 78a is attached to second plate 78b, such as through a welded connection. In other examples, second tubing 78a extends through second plate 78b and second plate 78b presses a portion of second tubing 78a into sealing contact with blower housing 49b. Second plate 78b is adjacent a flat surface of blower housing 49b and secured to blower housing 49b through a bolted connection. Second plate 78b can include a seal that contacts blower housing 49b and facilitates the airtight seal between second plate 78b and second blower 46b.

In the example shown, heater 50 is secured to both of blowers 46 through bolted connections. In another example, heater 50 can be secured to both of blowers 46 through a welded connection or any other connection suitable for securing heater 50 to blowers 46 and supporting heater 50 relative to blowers 46 and heater duct 52. FIG. 2E shows thermal assembly 22 with splitter 128. Splitter 128 is attached to heater duct 52 at the lower end of heater duct 52 and is configured to split and direct the air from blowers 46 into vent assembly 54. Splitter 128 guides the air into both lateral sides of vent assembly 54

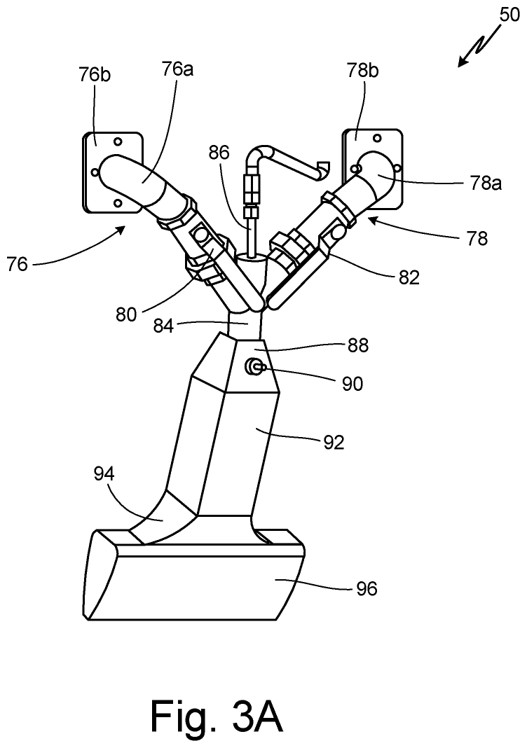

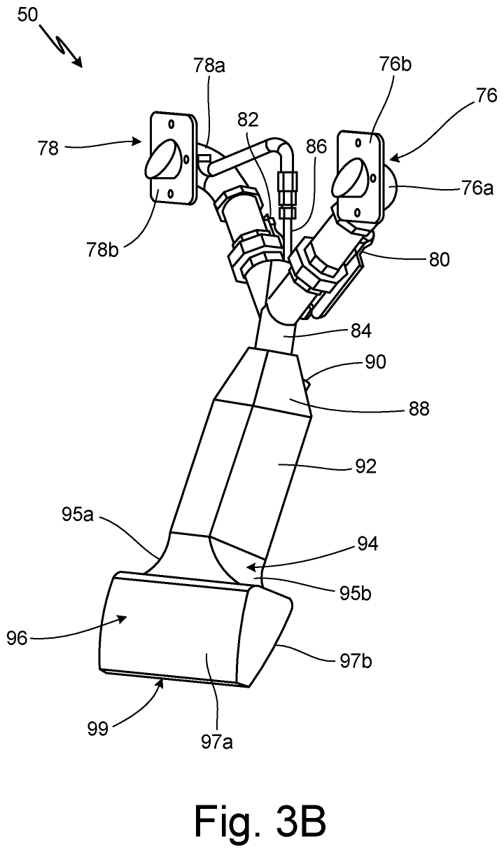

FIG. 3A is a front isometric view of heater 50. FIG. 3B is a rear isometric view of heater 50. FIGS. 3A-3B will be discussed together. Heater 50 includes first air inlet 76, second air inlet 78, first air valve 80, second air valve 82, chamber inlet 84, fuel inlet 86, ignition chamber 88, ignitor 90, burning chamber 92, curved portion 94, and nozzle 96. First air inlet 76 includes first tubing 76a and first plate 76b. Second air inlet 78 includes second tubing 78a and second plate 78b.

Heater 50 is configured to receive a pressurized air stream from first blower 46a and second blower 46b. Each of first blower 46a and second blower 46b have an aperture extending through the housing that is configured to allow pressurized air to travel from first blower 46a and second blower 46b into first air inlet 76 and second air inlet 78, respectively. The pressurized air that enters first air inlet 76 and second air inlet 78 travels to first air valve 80 and second air valve 82, respectively. First air valve 80 and second air valve 82 are configured to regulate the amount of pressurized air that enters heater 50. In this example, first air valve 80 and second air valve 82 are manual air valves in which a user manually turns a handle to adjust the size of the orifice within the valve. In other examples, first air valve 80 and second air valve 82 are electrically operated valves that can be controlled open and closed by controller 24 such that controller 24 can adjust the size of the orifice within each valve 80, 82.

The pressurized air that passes first air valve 80 and second air valve 82 travels to chamber inlet 84 where the two streams of pressurized air are combined into a single stream of mixed air. Fuel inlet 86 is connected to chamber inlet 84 and fuel inlet 86 is configured to inject fuel into chamber inlet 84 to be mixed with the pressurized air from first air inlet 76 and second air inlet 78. In some examples, a fuel spray nozzle extends beyond the location in chamber inlet 84 where the air streams meet. Fuel inlet 86 is connected to fuel tanks 16 through a tube or hose connection and fuel inlet 86 receives fuel from fuel tanks 16. The fuel that is injected through fuel inlet 86 can be natural gas, liquid propane, and other liquefied petroleum gas, among other options. The fuel that is injected into chamber inlet 84 is mixed with the pressurized air from first air inlet 76 and second air inlet 78 and then the mixture travels to ignition chamber 88.

Ignition chamber 88 is fluidly connected to chamber inlet 84 and ignition chamber 88 is disposed below chamber inlet 84. Ignition chamber 88 receives the mixture of fuel and air from chamber inlet 84 and the mixture is ignited by ignitor 90. Ignitor 90 provides the spark that ignites the fuel and air mixture received from chamber inlet 84. It is understood that the ignitor can be a spark plug, a glow plug, a piezo ignitor, or any other suitable ignition device. The ignited air and fuel mixture travels from ignition chamber 88 to burning chamber 92. The inlet of burning chamber 92 at the intersection of ignition chamber 88 and burning chamber 92 is narrower than the middle section of the chamber. As the ignited fuel and air mixture enters burning chamber 92, the configuration of the burning chamber 92 causes the flow to divide into streams that follow and run along the walls of burning chamber 92. This configuration of flow of the ignited fuel and air mixture creates a reduced pressure region such as a negative pressure region in the central portion of burning chamber 92 and as a result, turbulence of the ignited fuel and air mixture is created in the central portion of burning chamber 92. The turbulence within burning chamber 92 creates mini whirlpools that further mix the ignited fuel and air mixture. Further mixing of the ignited fuel and air mixture increases the burning efficiency of the mixture, which in turn reduces the amount of fuel that is used during operation of row crop machine 10. In some examples, the outlet of burning chamber 92 is narrower than the middle section of burning chamber 92, similar to the inlet of burning chamber 92, creating a pressurized ejection of the ignited fuel and air mixture into curved portion 94. As such, burning chamber 92, which can also be referred to as a combustion chamber, can have a first width proximate the pre-ignition chamber, a second width proximate the nozzle, and a third width intermediate the first width and the second width.

Curved portion 94 is connected to and positioned below burning chamber 92. Curved portion 94 widens the flame path (ignited fuel and air mixture) as the flame enters nozzle 96. Curved portion 94 includes first curve 95a on a first lateral side of curved portion 94 and second curve 95b on a second lateral side of curved portion 94. Nozzle 96 is connected to and positioned below curved portion 94. The inlet of nozzle 96 is wider longitudinally than the outlet 99 of nozzle 96, creating an increase in pressure and velocity of the flame as the flame exits nozzle 96. Nozzle 96 has an elongated width and curved longitudinal edges 97a, 97b extending to the outlet 99 of nozzle 96. The curved edges provide a curved delta configuration for nozzle 96 decreasing the longitudinal width between the entrance and outlet 99. The configuration of nozzle 96 again creates a Coanda effect in the nozzle 96 that opens and widens the flame. The flame can be ejected from nozzle 96 as a sheet. Curved longitudinal edges 97a, 97b can extend from the entrance of nozzle 96 to outlet 99.

Burning chamber 92 extends through an aperture in heater duct 52 and nozzle 96 is positioned within cavity 98 of heater duct 52 (FIG. 2A). Nozzle 96 is configured to eject the flame traveling through heater 50 into heater duct 52. The flame that is ejected into heater duct 52 is then mixed with the air streams created by blowers 46, heating the streams of air produced by blowers 46.

Heater 50 is configured to heat the air stream generated by blowers 46. In some examples, heater 50 is fuel-powered such that heater 50 receives fuel from fuel tanks 16, combusts the fuel, and produces a flame jet that extends into heater duct 52. For example, heater 50 can be an atmospheric burner. The air streams generated by blowers 46 can pass through the flame jet to be heated by the flame jet. While the air streams are described as passing through the flame jet, it is understood that the flame jet can be provided within its own enclosure to affect a heat exchange relationship between the enclosure and the air streams.

Referring to FIGS. 2A-2C, heater duct 52 includes cavity 98, body 100, curved connection 102, vent section 104, mounting section 106, and vent attachments 108a, 108b. Cavity 98 is an open section within body 100 of heater duct 52 that is configured to receive pressurized air streams from first blower 46a and second blower 46b. Cavity 98 is also configured to receive the flame from heater 50. The air streams from blowers 46 flow through the flame from heater 50 and the air streams are heated by the flame. Body 100 and cavity 98 taper from a wider opening to a smaller opening moving down toward vent section 104 and the cross-sectional area of cavity 98 is reduced as the air travels down to vent section 104. The configuration of cavity 98 increases a pressure of the heated air as the heated air travels through heater duct 52 towards vent section 104. Likewise, the configuration of cavity 98 increases the velocity of the air as the air travels through heater duct 52 towards vent section 104. As the air travels through cavity 98, the air enters curved connection 102.

Curved connection 102 connects body 100 of heater duct 52 to vent section 104 of heater duct 52. Curved connection 102 is configured to allow the pressurized heated air to smoothly flow from cavity 98 into vent section 104. Curved connection 102 is also configured to evenly distribute the pressurized heated air to vent section 104 and thus out to the two lateral sides of vent assembly 54. Curved connection 102 includes curved lateral sides 103. Vent section 104 is positioned below and connected to curved connection 102. Vent section 104 is configured to receive the pressurized heated air from cavity 98 and expel a portion of the air through vents and distribute the other portions of the air to vent assembly 54. Mounting section 106 is positioned at the bottom of vent section 104 and heater duct 52. Mounting section 106 is configured to receive vent attachments 108a, 108b to change the blowing configuration of row crop machine 10. Vent attachments 108a, 108b can be removably connected to mounting section 106 in any desired manner, such as a bolted connection. Vent attachments 108a, 108b include varying vent patterns which allow the user to interchange vent attachments 108a, 108b depending on the desired vent pattern (discussed further below). In operation, pressurized heated air travels through cavity 98 to vent section 104 where a portion of the air is dispensed through the vents of vent attachments 108a, 108b and the other portion of the pressurized heated air travels to vent assembly 54. Vent attachments 108a, 108b allow row crop machine 10 to provide thermal treatment to any row crops disposed directly below thermal assembly 22.

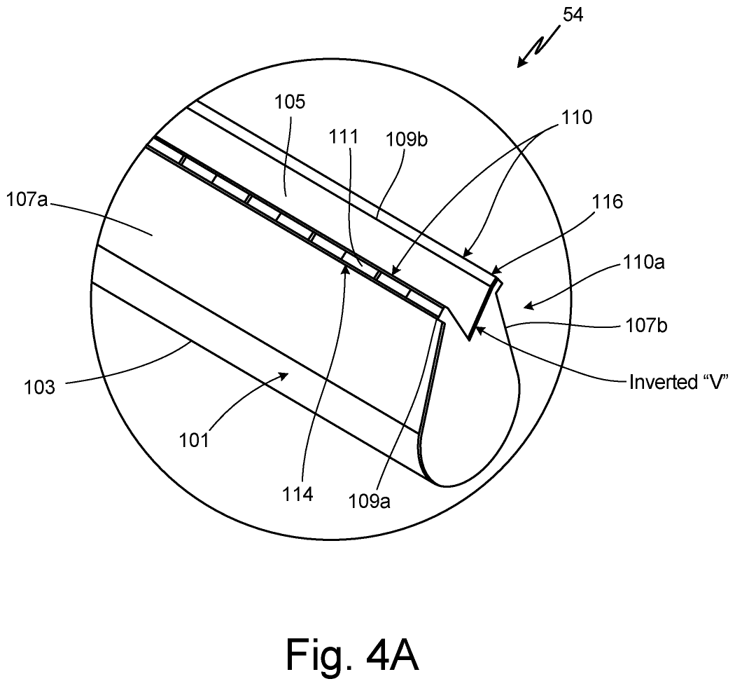

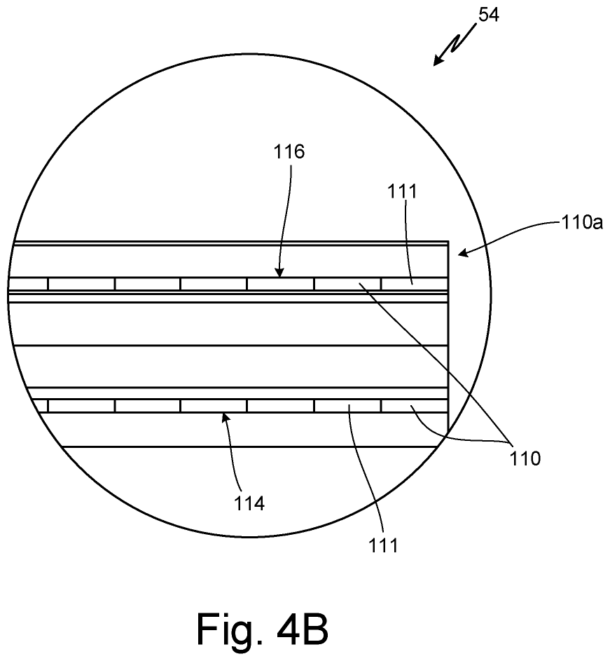

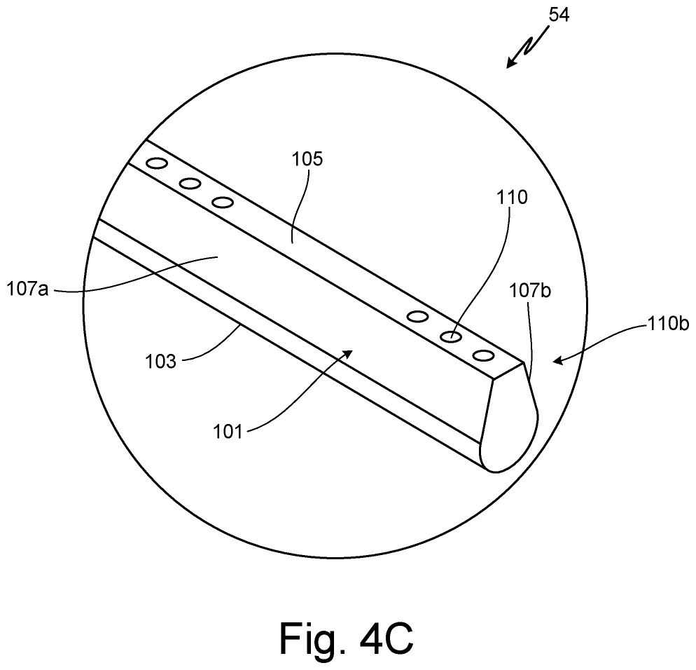

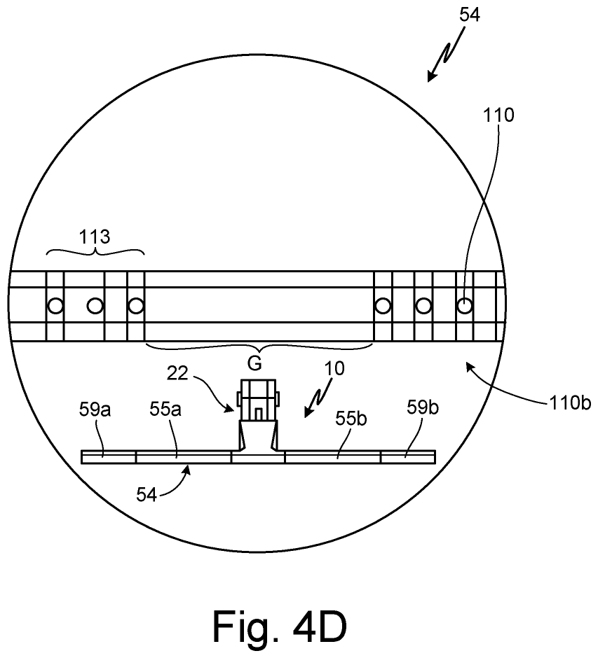

Referring to FIGS. 1A and 2A, vent assembly 54 is located on first and second sides of row crop machine 10. Each vent arm 55a, 55b of vent assembly 54 is attached to a flanges 53a, 53b of heater duct 52, such as through a bolted connection. For example, each vent arm 55a, 55b can include its own flange 57a, 57b interfacing with and connecting to flanges 53a, 53b. Vent arms 55a, 55b extend outward from heater duct 52 and are configured to receive pressurized heated airflow from vent section 104 of heater duct 52. In this example, vent assembly 54 is shown as a continuous vent assembly 54. In other examples, vent assembly 54 can include connection points at the distal ends of vent arms 55a, 55b that allow vent extensions 59a, 59b (FIG. 4D) to be mounted to vent arms 55a, 55b, extending the width of row crop machine 10 and allowing row crop machine 10 to treat more rows simultaneously. In some examples, row crop machine 10 can treat four rows, each about 1 meter wide. In some examples, vent extensions 59a, 59b each provide an additional row of treatment capacity, which can be about 1 meter wide. As such, row crop machine 10 is modular and can be expanded or contracted as needed to provide treatment.

The extensions 59a, 59b can have any desired vent configuration, including bi-directional and uni-directional. In another example, vent assembly 54 can include a telescoping vent arms 55a, 55b in which vent arms 55a, 55b can be extended outward to a desired length, extending the width of row crop machine 10. Extending row crop machine 10 provides the advantage of a wider reach of row crop machine 10, allowing the user to treat more rows with one pass of row crop machine 10.

Vent arms 55a, 55b and vent section 104 of heater duct 52 have an inverted droplet shape that is configured to maintain the pressure within vent assembly 54 to ensure that the air flows across the full width of vent assembly 54. The body 101 of vent arms 55 is wider at the top portion and narrower at the bottom portion where the air is ejected through air vents 110 onto the crops to form the inverted droplet. The longitudinal sides 107a, 107b converge from the top of body 101 to the bottom of body 101 to form the inverted droplet shape. The top 103 of body 101 is curved, but it is understood that the top 103 can be of other configurations. The bottom 105 is flat in the uni-directional configuration and forms the inverted “V” in the bi-directional configuration. The inverted droplet shape causes the air to increase in pressure and velocity as the air nears air vents 110. Air vents 110 are positioned on a bottom side of vent assembly 54 and point toward the ground to apply the heated air onto the crops below row crop machine 10. The pressurized heated air that exits through vent assembly 54 allows a user to treat multiple rows of crops at the same time, thereby increasing the efficiency of the TPT process.

Vent assembly 54 is configured to function in both the extended state (FIG. 1A) and the collapsed state (FIG. 1H). A user may want to operate row crop machine 10 in the collapsed state if the crops that are being treated grow vertically, such as on a trellis. In the collapsed state, vent assembly 54 can include flexible tubing 112 that is connected between vent section 104 and vent assembly 54. Flexible tubing 112 is configured to maintain an airtight connection between vent section 104 and vent assembly 54 such that pressurized heated air traveling from vent section 104 travels through flexible tubing 112 to vent assembly 54. Flexible tubing 112 can be a metal, polymer, or any other material suitable for an airtight connection between vent section 104 and vent assembly 54. When in the collapsed state, vent assembly 54 can be disposed at any desired angle relative to the target plants to apply heated air onto the crops.

FIG. 4A is an isometric view of vent assembly 54 with bi-directional air vent 110a. FIG. 4B is a bottom view of vent assembly 54 with bi-directional air vent 110a. FIG. 4C is an isometric view of vent assembly 54 with uni-directional air vent 110b. FIG. 4D is a bottom view of vent assembly 54 with uni-directional air vent 110b. FIGS. 1A, 2A, and 4A-4D will be discussed together. Vent assembly 54 can include bi-directional air vents 110a or uni-directional air vents 110b. Row crop machine 10 is modular and vent assemblies 54 having the different air vent configurations can be swapped to allow row crop machine 10 to operate in either desired configuration. Vent assembly 54 is interchangeable depending on which air vent configuration is desired by the user. Bi-directional air vents 110a may be preferred for certain crops and/or application protocols while uni-directional air vents 110b may be preferred for other crops and/or application protocols. To interchange vent assembly 54, the user removes the bolts securing vent assembly 54 to heater duct 52 (FIG. 2A), removes vent assembly 54 from heater duct 52, and then secures the other vent assembly 54 to heater duct 52.

Bi-directional air vents 110a (FIGS. 4A-4B) divide the pressurized heated air into two air streams at the narrow part of the inverted “V” outlet design. The “V” outlet includes two vent sections 109a, 109b. The angle of the inverted “V” projects the heated air at an angle intermediate vertical and horizontal with respect to the ground surface and in relation to the target crop as row crop machine 10 traverses the field. Bi-directional air vents 110a have an alternating open-closed air distribution outlet system along both sides of the inverted “V” shaped exits and along the length of vent assembly 54. More specifically, on each side of the inverted “V” shaped exits there is a rectangular opening 110 (allowing heated air to exit vent assembly 54) followed by a rectangular block 111 (blocking heated air from exiting vent assembly 54). The open-closed air distribution outlet can continue across the entire length of vent assembly 54. On the other side of the inverted “V” shaped exit, the open-closed distribution is opposite the open-closed distribution of the first side. When the first side of the inverted “V” shaped outlet has an open aperture, directly across on the other side of the inverted “V” shape can include a closure. As such, the opposing sides of the inverted “V” shaped outlet are not mirror images of each other. Rather, the open-closed distribution is opposite on each side of the inverted “V” shaped outlet. The open-closed distribution helps maintain the pressure in vent assembly 54 and distributes the heated air evenly over the length of vent assembly 54. It is understood, however, that the two sides of the inverted “V” shaped outlet can be mirror images, in some examples. The openings 110 and the closures 111 can have the same or varying widths. In some examples, each of openings 110 and closures 111 can be about 2 inches wide.

The vent sections 109a, 109b and thus air vents 110 (apertures) on each side of the inverted “V” shaped outlet are disposed on transverse axes to apply the heated air in transverse directions. The transverse orientation ensures that the heated air fully penetrates the plant canopy to increase the temperature throughout the entire plant canopy. First vent row 114 and second vent row 116 direct the first portion of the heated air stream and the second portion of the heated air stream, respectively, onto the target crop at angles transverse to each other. The heated airflow is directed in a downward direction onto the crop disposed below first vent row 114 and second vent row 116. As described above, first vent row 114 directs the first portion of the heated air stream in a first, forward direction (direction the tow vehicle is traveling), while second vent row 116 directs the second portion of the heated air stream in a second, rearward direction (opposite direction the tow vehicle is traveling).

As row crop machine 10 traverses the field, first vent row 114 applies the first portion of the heated air onto the plant canopy. First vent row 114 applies the first portion to the plant as row crop machine 10 approaches the plant and as thermal assembly 22 passes over the plant. Directing the first portion in this manner enhances the penetration of the first portion into the area surrounding the plant. The first portion is directed at such an angle that the first portion flows both above and below surfaces, such as leaves, of the target plant. Flowing the heated air between the leaves of the target plant enhances the penetration of the first portion of the heated air into the core of the plant, and ensures that the temperature increases not only in the outer layers of the plant, but across the entirety of the plant. Increasing the temperature profile for the entire plant provides increased benefits as the full plant reacts to the increased temperature, thereby causing the plant to provide an increased number of fruit, increased size of fruit, and decreasing the time to harvest. In addition, some pests tend to reside on the underside of leaves. Configuring the air stream to flow under the leaves allows those pests to be treated via TPT.

Second vent row 116 applies the second portion of the heated air transverse to first vent row 114. Second vent row 116 applies the second portion to the plant as thermal assembly 22 passes over the plant and as row crop machine 10 moves away from the plant. The heated air is blown onto the plant canopy. Directing the second portion in this manner enhances the penetration of the second portion into the area surrounding the core of the plant. The second portion is directed at such an angle that the second portion flows both above and below the leaves of the target plant. Flowing the heated air between the leaves of the target plant enhances the penetration of the second portion of the heated air into the core of the plant, and ensures that the temperature increases not only in the outer layers of the plant, but across the entirety of the plant. Increasing the temperature profile for the entire plant provides increased benefits as the full plant reacts to the increased temperature, thereby causing the plant to provide an increased number of fruit, increased size of fruit, and decreasing the time to harvest.

Applying the first portion and the second portion provides additional benefits. Applying the first portion ensures that the first portion penetrates the plant canopy from a first side of the plant as row crop machine 10 approaches the plant. However, the first portion may impinge on only the tops of leaves as thermal assembly 22 passes over the plant. Applying the second portion ensures the second portion penetrates the plant canopy from a second side of the plant as row crop machine 10 moves away from the plant. The transverse orientation of first vent row 114 and second vent row 116 thereby ensures that the heated air penetrates the plant canopy from both the first side of the plant and the second side of the plant. As such, the heated air penetrates to the core of the plant canopy from opposite directions, ensuring that the whole of the plant canopy is heated.

Uni-directional air vents 110b (FIGS. 4C-4D) project the heated air in a vertical orientation out the bottom of vent assembly 54 onto the target crops. Uni-directional air vents 110b project the air through a plurality of sets 113 of circular openings. It is understood, however, that the openings can be of any desired configuration, such as oval, square, or rectangular, among other options. Each set 113 can be formed by a set number of holes spaced a desired distance apart. The holes forming each set 113 can be aligned on a centerline of the bottom of the vent arm. In the example shown, the set can be formed by four holes having diameters of 1.5 inches that are spaced about 1.75 inches from the center to center of each hole. Each set of holes is distributed along the length of vent assembly 54 and spaced from adjacent hole sets by gap G. In some examples, the hole sets are spaced about 19.6 inches (about 50 centimeters) from the edges of the outer holes of each set. The gap G between adjacent sets of holes helps maintain the pressure in vent assembly 54 and distributes the heated air evenly over the length of vent assembly 54. In some examples, gap G is wider than one or more of sets 113. Uni-directional air vents 110b projects the heated air vertically directly onto the plants below vent assembly 54 as row crop machine 10 traverses a field and vent assembly 54 is positioned above the target crops.

Referring to FIG. 2A, vent attachments 108a, 108b can include either bi-directional air vent 110a or uni-directional air vent 110b. Vent attachment 108a that includes the bi-directional air vent 110a pattern has two parallel sets of open-closed air distribution outlets along the length of vent attachment 108a. Vent attachment 108b that includes the uni-directional air vent 110b pattern has a total of 4 holes, 2 sets of 2 holes, one set at each side of vent attachment 108. It is understood, however, that the holes can be disposed in any desired configuration. The holes maintain the same distribution and distance between them as vent assembly 54. Vent attachments 108a, 108b are interchangeable depending on which air vent 110 configuration is desired by the user. Bi-directional air vents 110a may be preferred for certain crops while uni-directional air vents 110b may be preferred for other crops. To interchange vent attachments 108a, 108b, the user removes the bolts securing vent attachment 108a, 108b to mounting section 106 of heater duct 52, removes vent attachment 108a, 108b from heater duct 52, and then secures the other vent attachment 108a, 108b to heater duct 52 through a bolted connection.

During operation, row crop machine 10 is traversed through a field to provide TPT to the row crops. Row crop machine 10 is connected to a tow vehicle by hitch 26. In examples where power source 18 is a PTO-powered electric generator, the PTO shaft of the tow vehicle is connected to power source 18. In examples where power source 18 is a fuel-powered electric generator, the fuel flow to power source 18 is initiated and power source 18 is activated. In examples where power is provided directly from the tow vehicle, row crop machine 10 is electrically connected to the tow vehicle in the required manner, such as by a plug on the tow machine or directly to the battery of the tow machine. Row crop machine 10 is towed through the field at a desired speed for the application process. For example, row crop machine 10 can traverse the field at a rate of about 1-15 mph (about 1.5-25 kph). Row crop machine 10 preferably traverses the field at about 1-5 mph (about 1.5-8 kph). As row crop machine 10 traverses the field, thermal assembly 22 blows heated air streams onto the plants or crops.

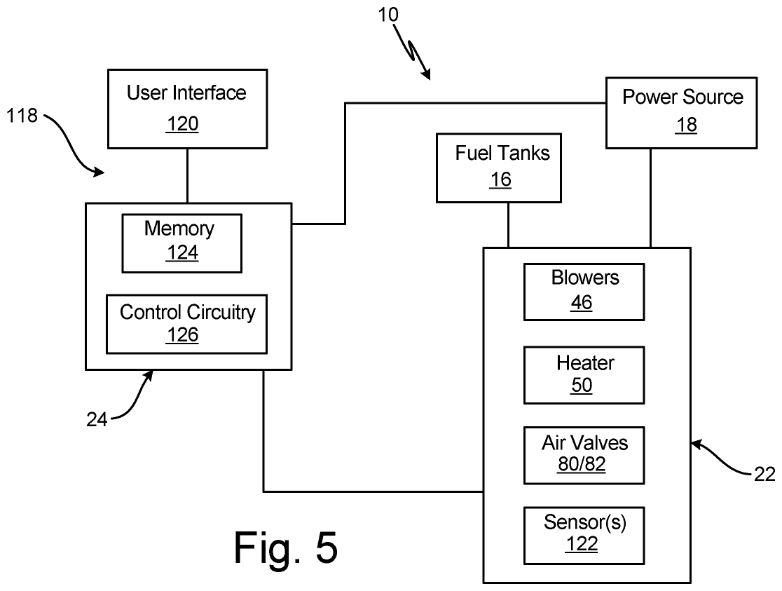

Thermal assembly 22 and vent assembly 54 apply the heated air to the crops positioned below the thermal assembly 22 and vent assembly 54. The fuel flow between fuel tanks 16 and heater 50 is initiated and ignitor 90 is powered. In some examples, the user manually opens a valve between fuel tanks 16 and heater 50 to control the fuel flow to heater 50. Controlling the fuel flow to heater 50 controls the intensity of the flame generated by heater 50, thereby controlling the temperature of the heated air stream. In other examples, the fuel flow can be automatically controlled by a controller, such as controller 24 (FIGS. 1B and 5). In another example, the intensity of the heat on the crops can be controlled by raising or lowering the height of thermal assembly 22 with respect to the crops on the ground. The fuel is ignited by ignitor 90 and heater 50 projects the flame into heater duct 52.

Power source 18 provides power to blower shaft 48 to drive the rotation of the fans 47a, 47b of blowers 46. Blowers 46 pull atmospheric air through intake 74, compress the air, and generate the air streams that are provided to heater duct 52. The air streams pass through the flame generated by heater 50, which increases the temperature of the air stream to generate the heated air stream. The heated air stream is driven through heater duct 52 into vent section 104. Vent section 104 splits the heated airstream into a first part, provided to and ejected by a first side of vent assembly 54, and a second part, provided to and ejected by a second side of vent assembly 54.

FIG. 5 is a block diagram of control system 118. Control system 118 includes row crop machine 10, controller 24, and user interface 120. Fuel tanks 16, power source 18, thermal assembly 22, blowers 46, heater 50, air valves 80,82, and sensor(s) 122 of row crop machine 10 are also shown. Controller 24 includes memory 124 and control circuitry 126. Power source 18 is electrically connected to thermal assembly 22 to provide electrical power to thermal assembly 22. The power supplied by power source 18 powers blowers 46 and provides energy to generate the ignition spark for heater 50. Power source 18 can also provide power to air valves 80,82, such as where air valves 80,82 are electrically actuated, such as by a solenoid.

Controller 24 is attached to support arms 28 of frame 12 (FIG. 1B) and is communicatively coupled to send data to and receive data from row crop machine 10. Controller 24 can be communicatively coupled through either wired or wireless connections. Control circuitry 126 can include one or more processors, configured to implement functionality and/or process instructions. For example, control circuitry 126 can be capable of processing instructions stored in memory 124. Examples of control circuitry 126 can include any one or more of a microprocessor, a controller, a digital signal processor (DSP), an application specific integrated circuit (ASIC), a field-programmable gate array (FPGA), or other equivalent discrete or integrated logic circuitry.

Memory 124 can be configured to store information within controller 24 during operation. Memory 124, in some examples, are described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 124 is a temporary memory, meaning that a primary purpose of memory 124 is not long-term storage. Memory 124, in some examples, is described as volatile memory, meaning that memory 124 does not maintain stored contents when power to controller 24 is turned off. Examples of volatile memories can include random access memories (RAM), dynamic random-access memories (DRAM), static random-access memories (SRAM), and other forms of volatile memories. In some examples, memory 124 is used to store program instructions for execution by control circuitry 126. Memory 124, in one example, is used by software or applications running on controller 24 to temporarily store information during program execution.

Memory 124, in some examples, also includes one or more computer-readable storage media. Memory 124 can be configured to store larger amounts of information than volatile memory. Memory 124 can further be configured for long-term storage of information. In some examples, memory 124 includes non-volatile storage elements. Examples of such non-volatile storage elements can include magnetic hard discs, optical discs, floppy discs, flash memories, or forms of electrically programmable memories (EPROM) or electrically erasable and programmable (EEPROM) memories.

Controller 24 can include a user interface 120 for controlling operations of controller 24. User interface 120 can be any graphical and/or mechanical interface that enables user interaction with controller 74 and/or other components of control system 118. For example, user interface 120 can implement a graphical user interface displayed at a display device of user interface 120 for presenting information to and/or receiving input from a user. User interface 120 can include graphical navigation and control elements, such as graphical buttons, a graphical keyboard (e.g., a “soft keyboard”), or other graphical control elements presented at the display device. User interface 120, in some examples, includes physical navigation and control elements, such as physically actuated buttons, a keyboard, or other physical navigation and control elements. In general, user interface 120 can include any input and/or output devices and control elements that can enable user interaction with controller 24 and/or other components of control system 118.

In some examples, user interface 120 includes one or more dials, switches, buttons, or other inputs that control the supply of electrical energy to blowers 46 and air valves 80,82 to control the speed of blowers 46 and the degree of opening of air valves 80,82. The amount of voltage or current supplied can be proportionate with the degree of actuation of the dial, switch, or other input from neutral, such that actuating the dial, switch, or other input further from neutral supplies greater current or voltage to cause blowers 46 to generate a faster air stream or air valves 80,82 to open to a greater degree as compared to lesser deviation from neutral.

In some examples, controller 24 provides commands to air valves 80,82 and ignitor 90 of heater 50. Controller 24 provides commands to air valves 80,82 to control the flow of air to heater 40 and thereby control the intensity of the flame produced by heater 50. Controller 24 thereby controls the temperature of the hot air stream generated by thermal assembly 22. Controller 24 provides commands to heater 50 at start up to cause ignitor 90 of heater 50 to generate a spark and ignite the fuel flowing to heater 50. It is understood that ignitor 90 can be a spark plug, a glow plug, a piezo ignitor, or any other suitable ignition device. Controller 24 can further control the speed of the fan of blowers 46 and thereby control the air velocity of the hot air stream generated by thermal assembly 22 and the amount of oxygen flowing to heater 50. For example, controller 24 can provide commands to a fan controller associated with blowers 46 to speed up or slow down the rotation of the fans 47a, 47b of blowers 46. For example, controller 24 can control the speed of power source 18 to control the speed of fans 47a, 47b.

Sensor(s) 122 can be disposed in thermal assembly 22 and/or on row crop machine 10. Sensor(s) 122 are configured to provide information regarding the hot air stream and the TPT process to controller 24. For example, sensor(s) 122 can include a temperature sensor disposed within heater duct 52 and/or vent assembly 54 that is configured to sense the temperature of the hot air stream, generate temperature information, and provide the temperature information to controller 24. In some examples, sensor(s) 122 include a flame sensor 123 (shown in FIG. 2C) extending into heater duct 52 and configured to sense the flame generated by heater 50. Controller 24 can be configured to shut down the gas flow and/or thermal assembly 22 if flame sensor 123 does not sense the presence of the flame within a time period after ignition. In the embodiment shown, flame sensor 123 is an ultraviolet flame detector. In another example, flame sensor 123 can be a near infrared detector, an infrared detector, an infrared thermal camera, an ultraviolet detector, or any other device suitable for detecting the presence of flames. Sensor(s) 122 can also include an air velocity sensor disposed in or near the exit of vent assembly 54 that is configured to sense the velocity of the hot air stream, generate air velocity information, and provide the air velocity information to controller 24. In some examples, sensor(s) 122 also include ground speed sensors that are configured to sense the ground speed of row crop machine 10 as row crop machine 10 traverses the field, generate ground speed information, and provide the ground speed information to controller 24. For example, sensor(s) 122 can include a Hall-effect sensor configured to sense rotation of the wheels on which the row crop machine 10 rides. It is understood, however, that the ground speed of row crop machine 10 can be sensed in any desired manner, such as via a global positioning system (GPS) or global navigation satellite system (GNSS). Controller 24 can communicate the temperature information, flame information, air velocity information, ground speed information, and any other desired information to the user via user interface 120.

During operation, controller 24 can be configured to automatically control the heating profile generated by thermal assembly 22 and applied to the target crop. The heating profile can include, among other factors, the length of application, the temperature of the application, and the air speed of the application.

The user can input the desired heating profile via user interface 120 and store the desired heating profile in memory 124. In some examples, memory 124 can be pre-loaded with a variety of heating profiles suitable for different crop types, according to different field and weather conditions. The user can select the most-appropriate heating profile depending on the existing conditions. For example, when the TPT process is applied during cooler ambient temperatures, the temperature of the heated air steam can be lowered while still inducing the desired temperature change in the target plant. Controlling the air speed and temperature level based on external conditions provides greater fuel efficiency and reduces wear on components of row crop machine 10. Controller 24 can automatically control the position of air valves 80,82 and the speed of the fan of blowers 46 to control the heating profile. In other examples, the user can enter the desired temperature and air velocity information to controller 24 via user interface 120.

Controller 24 provides an actuation command to air valves 80,82 to open the flow of air to heater 50. Controller 24 also sends an ignite command to the ignitor of heater 50 to cause heater 50 to ignite the fuel. Controller 24 receives temperature information from sensor(s) 122 and can confirm that heater 50 is operating properly based on sensor(s) 122 indicating an increase in temperature and/or the presence of the flame. Controller 24 can also provide the temperature information to the user via user interface 120. Controller 24 also sends an activate command to the fan controller of blowers 46 to activate blowers 46 and cause blowers 46 to begin generating the air stream. Controller 24 receives air velocity information from sensor(s) 122 and can confirm that blowers 46 are operating properly based on sensor(s) 122 indicating an increase in air velocity. Controller 24 can also provide the air velocity information to the user via user interface 120.

Controller 24 provides commands to a fuel valve to initiate fuel flow to heater 50. Controller 24 provides a command to the ignitor of heater 50 to initiate combustion at heater 50. Controller 24 also provides a command to cause blowers 46 to begin generating the air streams. Sensor(s) 122 provide temperature and air speed information to controller 24, and controller 24 can adjust the airflow to heater 50, the speed of blowers 46, the fuel flow to heater 50, and other parameters based on the information from sensor(s) 122 to achieve the desired heating profile. Controller 24 can also provide the air speed and temperature information to the user via user interface 120. The user can control the air speed and temperature during operation by providing additional commands to controller 24 via user interface 120.

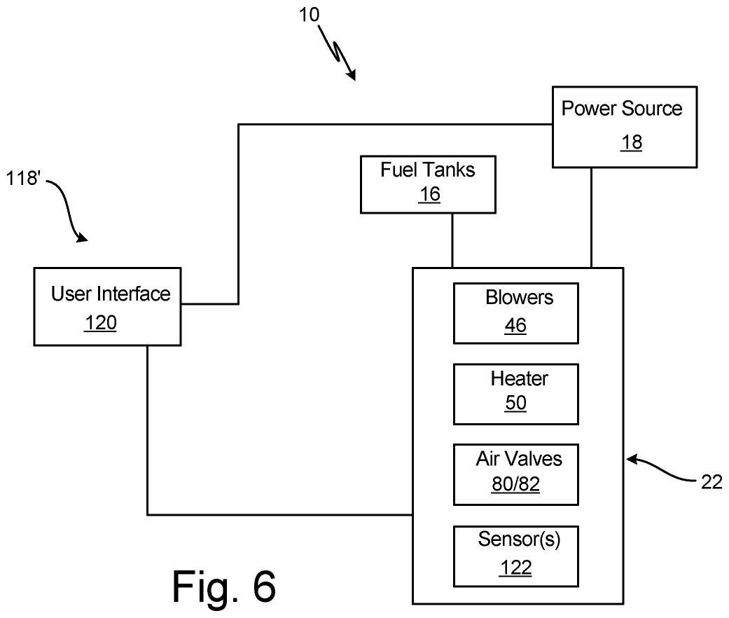

FIG. 6 is a block diagram of control system 118′ of row crop machine 10. Control system 118′ includes row crop machine 10 and user interface 120. Fuel tanks 16, power source 18, thermal assembly 22, and air valves 80,82 of row crop machine 10. Blowers 46, heater 50, and sensor(s) 122 of thermal assembly 22 are shown. Control system 118′ is similar to control system 118 (shown in FIG. 5), except in control system 118′ the user directly controls various components of row crop machine 10 with user interface 120.

User interface 120 is communicatively connected to various components within system 118′ in any desired manner, either via wired or wireless connections. User interface 120 can be any graphical and/or mechanical interface that enables user interaction with components of system 118′. For example, user interface 120 can implement a graphical user interface displayed at a display device of user interface 120 for presenting information to and/or receiving input from a user. User interface 120 can include graphical navigation and control elements, such as graphical buttons, a graphical keyboard (e.g., a “soft keyboard”), or other graphical control elements presented at the display device. User interface 120, in some examples, includes physical navigation and control elements, such as physically actuated buttons, a keyboard, or other physical navigation and control elements. In general, user interface 120 can include any input and/or output devices and control elements that can enable user interaction with components of system 118′.

In some examples, user interface 120 includes one or more dials, switches, buttons, or other inputs that control the supply of electrical energy to blowers 46 and air valves 80,82 to control the speed of blowers 46 and the degree of opening of air valves 80,82. The amount of voltage or current supplied can be proportionate with the degree of actuation of the dial, switch, or other input from neutral, such that actuating the dial, switch, or other input further from neutral supplies greater current or voltage to cause blowers 46 to generate a faster air stream or air valves 80,82 to open to a greater degree as compared to lesser deviation from neutral. While air valves 80,82 are described as being controlled via user interface 120, it is understood that air valves 80,82 can be manually controlled valves.

User interface 120 receives one or more of temperature information, air speed information, and ground speed information from sensor(s) 122. User interface 120 provides the information received from sensor(s) 122 to the user in any desired manner, such as a digital or analog visual output.

User interface 120 being remote from row crop machine 10 allows the user to control the heating profile of the heated air stream generated by thermal assembly 22 during operation of thermal assembly 22. The user can adjust one or both of the intensity of the flame generated by heater 50 and the air speed created by blowers 46 via user interface 120. As such, the user can control the temperature and air velocity from the cab of the tow vehicle, without requiring the user to stop the TPT process, exit the cab, and manually adjust the parameters.

Row crop machine 10 provides significant benefits. Power source 18 can be mounted on frame 12 and can be a fuel-powered generator or a mechanically powered generator. Power source 18 being a fuel-powered generator allows row crop machine 10 to be towed by any vehicle capable of towing row crop machine 10. Hitch 26 also allows row crop machine 10 to be connected to any desired tow vehicle. Hinge 34 allows vent assembly 54 to pivot to a collapsed state to reduce the width of row crop machine 10 and facilitate easier storage and transport. Further, hinge 34 allows vent assembly 54 to fold and operate when in the collapsed state, making row crop machine 10 capable of treating plants that grow vertically. Vent assembly 54 can also telescope or include attachment features to change the width of vent assembly 54, allowing row crop machine 10 to be adapted for use for a variety of crops and in a variety of field conditions. Vent assembly 54 is also interchangeable, allowing the user to swap one vent assembly 54 for another vent assembly 54 depending on the desired vent pattern, the crop that is being thermally treated, and the purpose of the treatment. Bleeding pressurized air from blowers 46 into heater 50 creates better burn efficiency, simplifies the design by reducing air tubing, and creates an overall more efficient and cost-effective row crop machine 10.

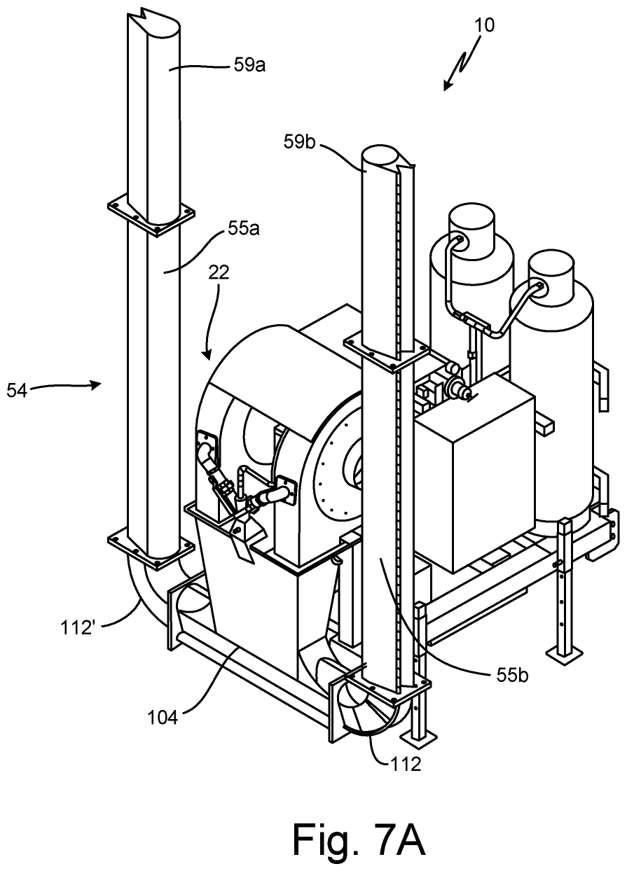

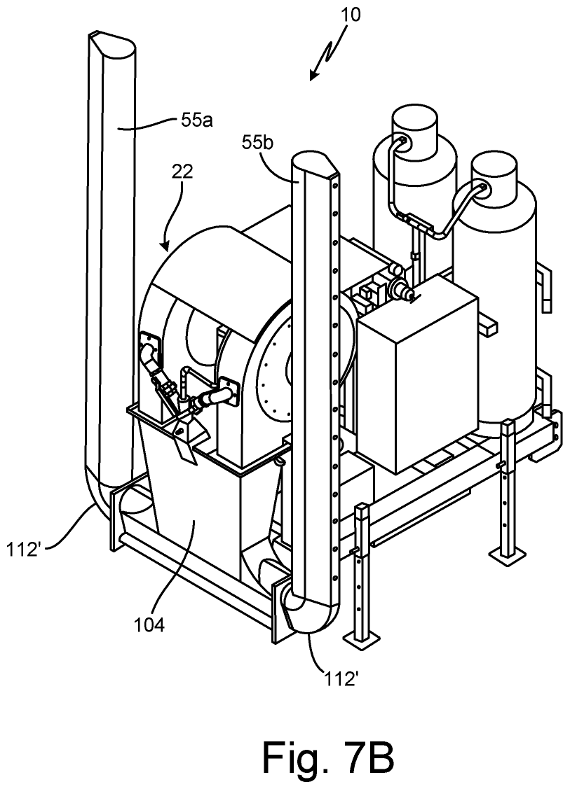

FIG. 7A is an isometric view of row crop machine 10 in a vertical treatment state. FIG. 7B is another isometric view of row crop machine 10 in a vertical treatment state. In FIGS. 7A and 7B, row crop machine 10 is shown in the state utilized to treat vertical crops, such as those grown on trellises. In such an arrangement, vent arms 55a, 55b are disposed on vertical axes and eject air laterally away from row crop machine 10. FIG. 7A shows row crop machine 10 with the bi-directional venting arrangement shown in FIGS. 4A and 4B. FIG. 7B shows row crop machine 10 with the uni-directional venting arrangement shown in FIGS. 4C and 4D.

To switch row crop machine 10 to the vertical treatment configuration, the vent attachment 108 is removed from below thermal assembly 22 and is replaced with a vent attachment that does not have openings therethrough. The vent attachment can be the same as those shown above but with the vent openings removed. Connectors 112′ are attached to each lateral side of the vent section 104. The connectors 112′ turn the heated airflow from flowing horizontally at the exit of vent section 104 to flowing vertically through vent arms 55a, 55b. In some examples, connectors 112′ provide a 90-degree bend between vent section 104 and vent arm 55a, 55b.

In FIG. 7A, vent extensions 59a, 59b are shown as attached at the distal ends of each vent arm 55a, 55b. Vent extensions 59a, 59b enlarge the treatment area of row crop machine 10 such that row crop machine 10 can treat a greater area with a single pass. As discussed above, the vent extensions 59a, 59b provide the expanded treatment area in both the horizontal configuration and the vertical configuration.

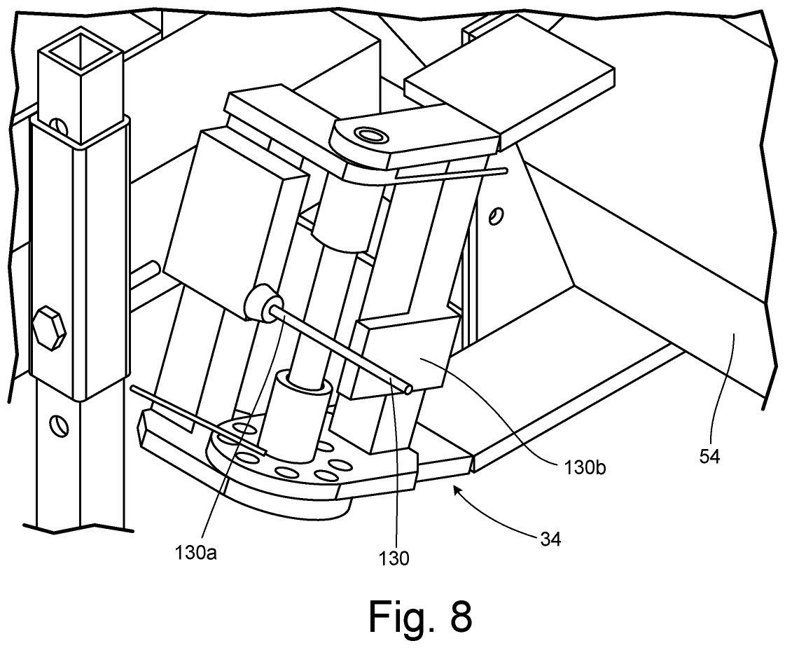

FIG. 8 shows hinge 34 with stop sensor 130. Stop sensor 130 is attached to hinge 34 and configured to prevent winch 42 from over-winding and causing damage to vent assembly 54 when shifting to the collapsed state. Stop sensor 130 operates when vent assembly 54 is being transitioned from the extended state to the collapsed state. Stop sensor 130 includes sensor components 130a, 130b. Stop sensor 130 is configured to generate a signal based on component 130a being in proximity to component 130b. In some examples, the signal is generated based on sensor component 130a contacting sensor component 130b. Stop sensor 130 can be of any type suitable for generating the signal. In some examples, component 130b is a plate that component 130a contacts. Component 130a contacting the plate generates strain on component 130a, which causes sensor 130 to generate the signal. The signal generated by sensor 130 causes the controller to stop the supply of energy to winch 42 when row crop machine 10 has reached the fully collapsed state. Preventing over-winding of winch 42 prevents damage to hinge 34 and vent assembly 54.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A thermal plant treatment (TPT) machine comprising:
a frame;
a thermal assembly supported by the frame, wherein the thermal assembly comprises:
a heater duct;
a blower assembly mounted on the heater duct, the blower assembly configured to generate and provide an airstream to the heater duct;
a heater supported by the blower and extending into the heater duct, the heater configured to increase a temperature of the air stream in the heater duct at a location downstream of the blower to generate a heated air stream; and
a vent assembly extending laterally relative to the heater duct and configured to receive the heated airstream from the heater duct and eject the airstream onto a target plant.

2. The TPT machine of claim 1, further comprising:
a fuel tank disposed on and supported by the frame;
a fuel line extending from the fuel tank to the heater, wherein the heater is configured to combust fuel from the fuel tank to increase the temperature in the heater duct.

3. The TPT machine of claim 1, and further comprising a power source supported by the frame, the power source configured to provide power to the blower, wherein the power source is selected from the group consisting of a fuel-powered electric generator and a mechanically driven electric generator.

4. The TPT machine of claim 1, wherein the blower assembly includes:
a first blower disposed on the heater duct and a second blower disposed on the heater duct; and
a blower shaft extending between and connecting a first fan of the first blower and a second fan of the second blower such that the first fan and the second fan are connected for simultaneous rotation.

5. The TPT machine of claim 4, further comprising:
a first air tube extending from the first blower to a common air tube;
a second air tube extending from the second blower to the common air tube;
a first air valve disposed on the first air tube; and
a second air valve disposed on the second air tube;
wherein the common air tube extends to the heater to provide a combined flow of air from the first blower and the second blower to the heater.

6. The TPT machine of claim 5, wherein the heater further comprises a heater body having a pre-ignition chamber, a combustion chamber extending from the pre-ignition chamber, and a nozzle extending from the combustion chamber and disposed at an opposite end of the combustion chamber from the pre-ignition chamber.

7. The TPT machine of claim 6, wherein:
the combustion chamber has a first width proximate the pre-ignition chamber, a second width proximate the nozzle, and a third width intermediate the first width and the second width;
the third width is larger than the first width; and
the third width is larger than the second width.

8. The TPT machine of claim 6, wherein the heater further comprises:
a curved connection portion extending between and connecting the combustion chamber and the nozzle, wherein the curved connection portion includes a first curve on a first lateral side and a second curve on a second lateral side, the first and second curves increasing a width of the flowpath between the combustion chamber and the nozzle.

9. The TPT machine of claim 5, wherein the a first longitudinal side of the nozzle is curved from an entrance of the nozzle to an exit of the nozzle and wherein a second longitudinal side of the nozzle is curved from the entrance to the exit, wherein the exit has an exit opening width and the entrance has an entrance opening width, wherein the exit opening width is smaller than the entrance opening width.

10. The TPT machine of claim 5, wherein the nozzle has a first lateral width, the first lateral width being larger than a lateral width of the combustion chamber.

11. The TPT machine of claim 1, wherein the vent assembly includes a first arm extending laterally relative to the frame and a second arm extending laterally relative to the frame.

12. The TPT machine of claim 11, wherein the first arm includes a bi-directional vent configured to eject the heated air onto the target plant, and wherein the bi-directional vent includes a first arm oriented on a first axis and a second arm oriented on a second axis, the second axis being transverse to the first axis.

13. The TPT machine of claim 12, wherein the first arm includes an alternating arrangement of vent openings and vent blockages.

14. The TPT machine of claim 11, wherein the first arm includes a uni-directional vent, and wherein the uni-directional vent includes a first set of openings and a second set of openings spaced from the first set of openings.

15. The TPT machine of claim 14, wherein the first and second sets of openings are aligned on a centerline of a bottom of the first arm.

16. The TPT machine of claim 14, wherein a gap between the first set of openings and the second set of openings is larger than a width of the first set of openings.

17. The TPT machine of claim 14, wherein the first set of openings includes a plurality of first openings, and wherein each of the plurality of first openings are circular.

18. The TPT machine of claim 1, wherein the thermal assembly includes a vent section disposed below the heater duct and connected to the heater duct.

19. The TPT machine of claim 18, wherein a vent attachment is removably mounted to the vent portion, the vent attachment including at least one opening configured to eject the heated air.

20. The TPT machine of claim 18, wherein the vent section is attached to the heater duct by a curved section disposed between the heater duct and the vent section, wherein lateral sides of the curved section are curved.
